(19) United States
(12) Patent Application Publication
(10) Pub. No.: US 2006/0073729 A1
(43) Pub. Date: Apr. 6, 2006

(54) Optical storage apparatuses

(75) Inventor: Huagen Guo, Suzhou (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/240,215

(22) Filed: Sep. 30, 2005

(30) Foreign Application Priority Data
Oct. 5, 2004 (TW) 93130088

(51) Int. Cl. H01R 11/00

(52) U.S. Cl. 439/502

(57) ABSTRACT

An optical storage apparatus comprises a mechanical device, a setting device and a control unit. The setting device comprises a first pin, a second pin and a third pin. The control unit electrically couples to the mechanical device and the setting device. When the first pin couples to the third pin, the control unit detects a voltage change occurring at the third pin and directs the mechanical device to perform a test.

### BACKGROUND

The invention relates to optical storage apparatuses, and more particularly, to optical storage apparatuses comprising a setting device to perform tests.

A conventional optical storage apparatus includes a transmission device with multiple transmission pins, a setting device determining whether the optical storage apparatus is a master apparatus or a slave one, and a switching device to switch the optical storage apparatus into a test mode. FIG. 1 is a diagram illustrating the reverse side of a conventional optical storage apparatus which comprises a setting device 13 and a switching device 15 at least. The setting device 13 comprises six pins P11 to P16 and a first jumper (not shown) selectively electrically coupling to two pins, such as pins P11 and P12, pins P13 and P14, or pins P15 and P16. The switching device 15 comprises two pins P17 and P18, and a second jumper (not shown) selectively electrically coupling pins P17 and P18.

FIG. 2 is a schematic diagram of a control circuit in a conventional optical storage apparatus in FIG. 1. The conventional optical storage apparatus comprises a control unit 11 with terminals 12 and 14, a setting device 13 and a switching device 15. The control unit 11 detects operating modes, transmits data and control signals, and controls mechanical devices (not shown). The terminal 12 of the control unit 11 electrically couples to power source VCC and pins P12, P14 and P16 via resistors R11 and R12. The pin 11 is grounded, the pin 13 is floating, and the pin 15 electrically connects to a transmission device such as an Integrated Device Electronics (IDE) connector. The terminal 14 of the control unit 11 electrically couples to power source VCC and the pin P18 via resistors R13 and R14. When the first jumper (not shown) electrically couples to the pins P11 and P12, the voltage level of the pin 12 is changed to the grounding level and the control unit 11 detects a logic zero signal via the terminal 12, representing that the optical storage apparatus is a master one. When the first jumper (not shown) connects to the floating pin P13 and the pin P14, the voltage level of the pin 14 is not changed and the control unit 11 detects a logic one signal via the terminal 12, representing that the optical storage apparatus is a slave one. When the second jumper (not shown) connects to the pins P17 and P18, the voltage level of the pin 18 is changed to the grounding level and the control unit detects a logic zero signal via the terminal 14, representing that the optical storage apparatus is set to perform a test.

The switching device in the conventional optical storage apparatus is provided for manufactures but has no practical use for customers, resulting in increasing cost.

SUMMARY

Optical storage apparatuses are provided. An embodiment of an optical storage apparatus comprises a mechanical device, a setting device and a control unit. The setting device comprises a first pin, a second pin and a third pin. The control unit electrically couples to the mechanical device and the setting device. When the first pin couples to the third pin, the control unit detects a voltage change occurring at the third pin and directs the mechanical device to perform a test.

### BRIEF DESCRIPTION OF THE DRAWINGS

The invention will become apparent by referring to the following detailed description of embodiments with reference to the accompanying drawings, wherein:

FIG. 1 is a diagram illustrating the reverse side of a conventional optical storage apparatus;

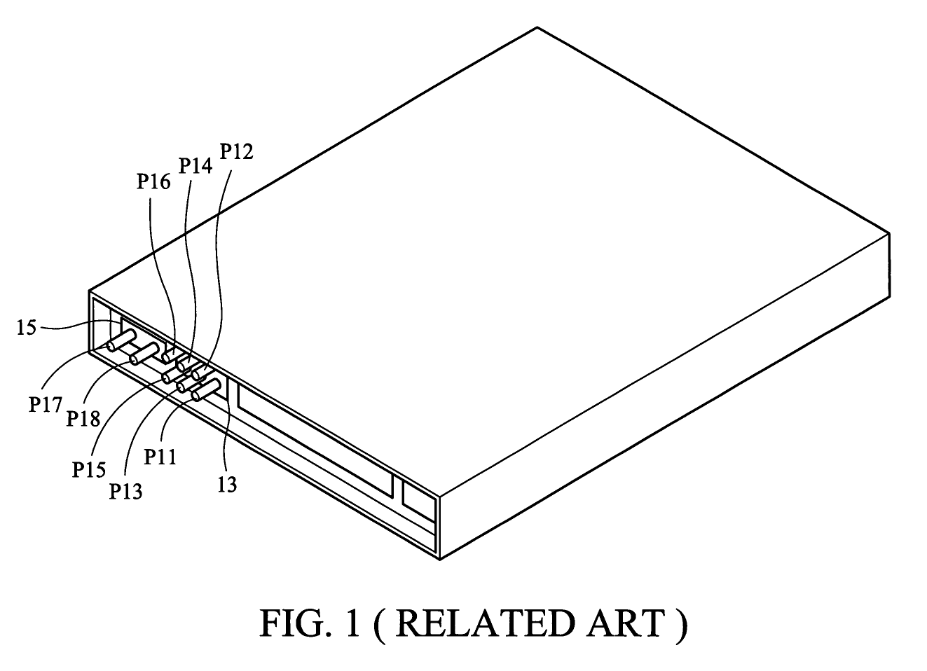

FIG. 2 is a schematic diagram of a control circuit in a conventional optical storage apparatus;

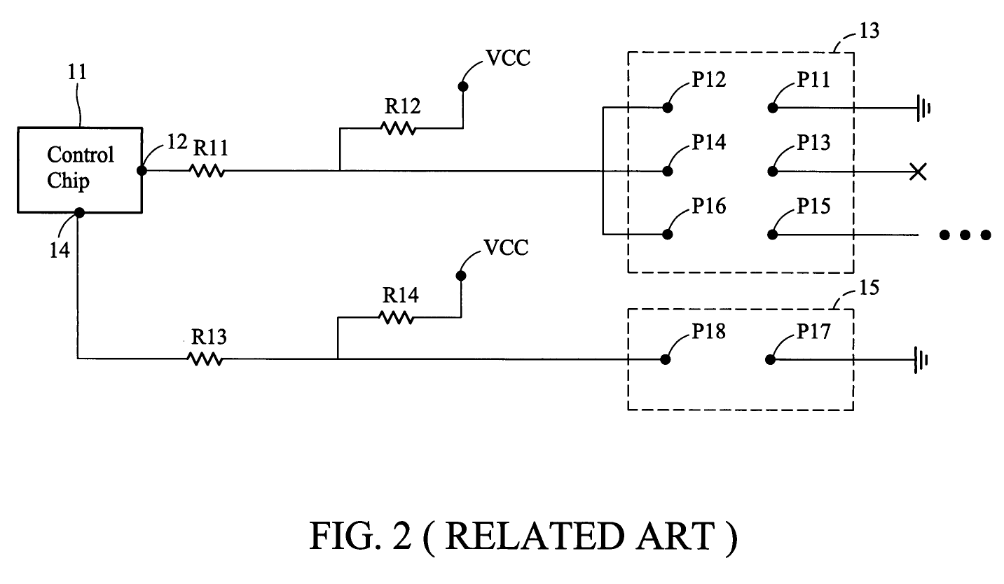

FIG. 3 is a diagram illustrating the reverse side of an embodiment of an optical storage apparatus;

FIG. 4 is a schematic diagram of a control circuit in an embodiment of optical storage apparatus.

### DESCRIPTION

Optical storage apparatuses comprise optical read drives and optical read/write drives. Optical read drives comprise CD-Read Only Memory (CD-ROM) drives reading CD-format data, DVD-Read Only Memory (DVD-ROM) drives reading DVD-format data, and SACD-Read Only Memory (SACD-ROM) drives reading SACD-format data. Optical read/write drives comprise CD-Read/Write (CD-RW) drives reading and writing CD-format data, DVD-Read/Write (DVD-RW) drives reading and writing DVD-format data, and SACD-Read/Write reading and writing SACD-format data.

Optical storage apparatus of the invention integrates the switching device with the setting device which electrically connects to a transmission device such as Integrated Device Electronics (IDE) connectors, Small Computer Standard Interface (SCSI) connectors, SATA connectors, Universal Serial Bus (USB) connectors, or others. An embodiment of an optical storage apparatus comprises a setting device comprising a first pin, a second pin and a third pin. The first pin is at a first voltage level such as a grounding level, and the second and third pins electrically couple to a control unit. When a jumper couples to the first and third pins, the control unit detects a voltage change occurring at the third pin (for example, the voltage level at the third pin is changed to the grounding level), indicating that the optical storage apparatus is set to perform a test. Thereafter, the control unit directs mechanical devices to perform the test, such as an aging test, enabling the mechanical devices to operate more smoothly.

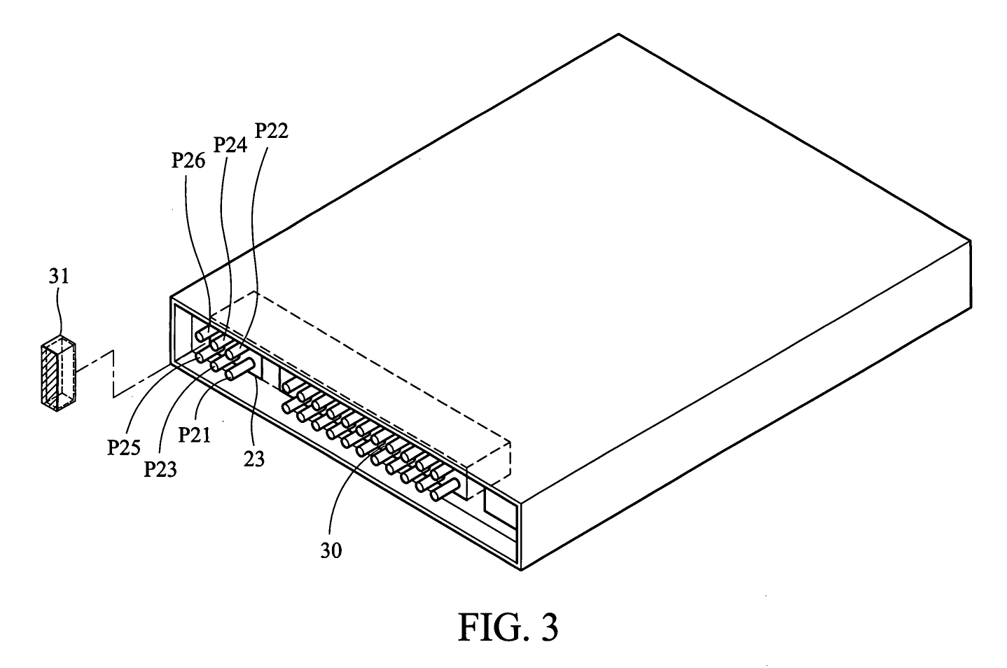

FIG. 3 is a diagram illustrating the reverse side of an embodiment of an optical storage apparatus, including a transmission device 30 and a setting device 23 for determining whether the optical storage apparatus is a master apparatus or a slave one. The setting device 23 electrically connects to the transmission device 30 and comprises six pins P21 to P26 and a jumper 31 selectively coupling to two pins, such as pins P21 and P22, pins P23 and P24, or pins P25 and P26. It should be understood that the transmission device 30 and the setting device 23 could be integrated into one connector, as shown in FIG. 3.

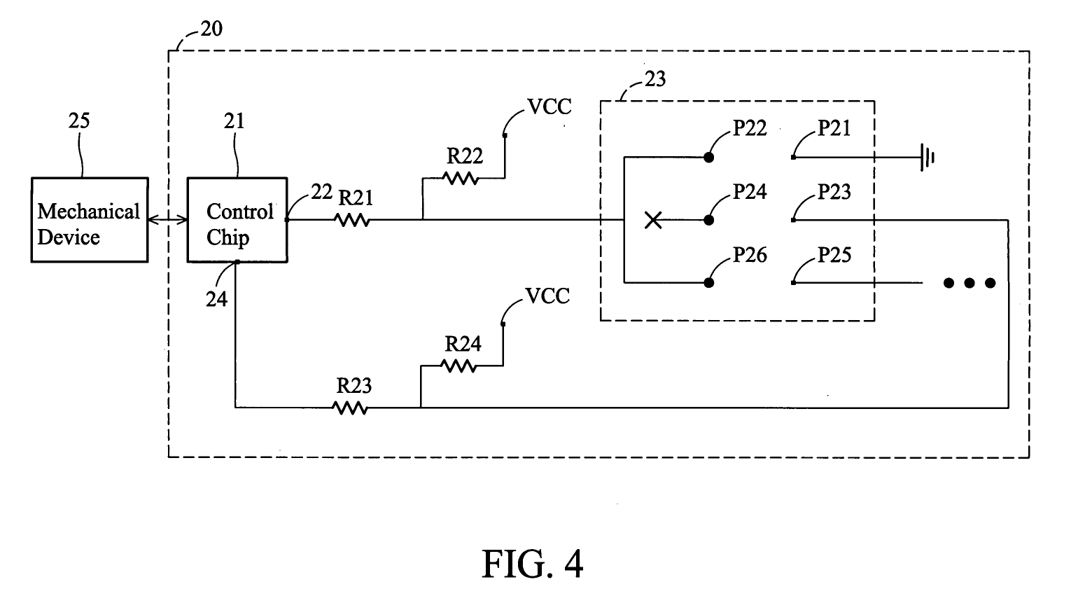

FIG. 4 is a schematic diagram of a control circuit in the optical storage apparatus in FIG. 3. The optical storage apparatus comprises a mechanical device 25, a control unit 21 with a first terminal 22 and a second terminal 24, and a setting device 23. The control unit 21 determines whether the optical storage apparatus is a master apparatus or a slave one, or is set to perform a test, via the setting device 23. The first terminal 22 of the control unit 21 electrically couples to power source VCC and pins P22 and P26 via resistors R21 and R22. The pin 21 is grounded, the pin 24 is floating, and the pin 25 couples to the transmission device 30 in FIG. 3. The second terminal 24 of the control unit 21 electrically couples to power source VCC and the pin P23 via resistors R23 and R24. When the jumper 31 in FIG. 3 couples to the pins P21 and P22, the voltage level of the pin 22 is changed to the grounding level and the control unit 11 detects a logic zero signal via the first terminal 22, representing that the optical storage apparatus is a master one. When the jumper 31 connects to the pins P23 and P24, the voltage level of the pin 23 is not changed and the control unit 21 detects a logic one signal via the second terminal 24, representing that the optical storage apparatus is a slave one. Otherwise, when the jumper 31 connects to the pins P21 and P23, the voltage level of the pin 23 is changed to the grounding level and the control unit detects a logic zero signal via the second terminal 24, representing that the optical storage apparatus is set to perform a test. Thereafter, the control unit 21 directs mechanical devices 25 to perform a test, such as an aging test, enabling the mechanical devices 25 to operate more smoothly.

Although the invention has been described in terms of preferred embodiment, it is not limited thereto. Those skilled in this technology can make various alterations and modifications without departing from the scope and spirit of the invention. Therefore, the scope of the invention shall be defined and protected by the following claims and their equivalents.

What is claimed is:

1. An optical storage apparatus comprising:
a mechanical device;
a setting device including a first pin, a second pin and a third pin; and
a control unit electrically coupling to the mechanical device and the setting device,
wherein when the first pin couples to the third pin, the control unit detects a voltage change at the third pin and directs the mechanical device to perform a test.

2. The optical storage apparatus of claim 1 wherein the first pin is at a first voltage level, and when the first pin couples to the third pin, the control unit detects that the third pin is changed to the first voltage level, and directs the mechanical device to perform the test.

3. The optical storage apparatus of claim 2 wherein the first voltage level is a grounding level.

4. The optical storage apparatus of claim 3 further comprising a jumper for electrically coupling the first pin to the third pin.

5. The optical storage apparatus of claim 3 wherein the setting device electrically connects to a transmission device.

6. The optical storage apparatus of claim 3 wherein the transmission device is an Integrated Device Electronics (IDE) connector.

7. The optical storage apparatus of claim 3 wherein when the first pin couples to the second pin, the control unit determines the optical storage apparatus is a master apparatus.

8. The optical storage apparatus of claim 3 wherein the setting device further includes a floating pin.

9. The optical storage apparatus of claim 8 wherein when the third pin couples to the floating pin, the control unit determines the optical storage apparatus is a slave apparatus.

10. The optical storage apparatus of claim 1 wherein when the mechanical device performs the test, the control unit includes a logic zero signal.

11. The optical storage apparatus of claim 1 wherein the optical storage apparatus is a CD-Read Only Memory (CD-ROM) drive, a DVD-Read Only Memory (DVD-ROM) drives or a SACD-Read Only Memory (SACD-ROM) drive.
